(19) United States
(12) Patent Application Publication
(10) Pub. No.: US 2026/0218675 A1
(43) Pub. Date: Jul. 30, 2026

(54) FUEL INJECTION VALVE AND INTERNAL COMBUSTION ENGINE

(71) Applicant: MITSUBISHI HEAVY INDUSTRIES ENGINE & TURBOCHARGER, LTD., Sagamihara-shi, Kanagawa (JP)

(72) Inventor: Hisao OGAWA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 19/157,957

(22) PCT Filed: Jan. 23, 2024
(86) PCT No.: PCT/JP2024/001795

§ 371 Date: Aug. 19, 2025

(30) Foreign Application Priority Data
Mar. 6, 2023 (JP) 2023-033920

(51) Int. Cl. F02M 61/16

(52) U.S. Cl. CPC F02M 61/165

(57) ABSTRACT

A fuel injection valve for an internal combustion engine is provided with: a fuel injection nozzle; a fuel passage for supplying fuel to the fuel injection nozzle; and an edge filter disposed in the fuel passage. The edge filter includes an edge filter body and a flange part disposed upstream of the edge filter body in the fuel passage. The fuel passage includes a fitting hole which mates with the edge filter body. A diameter of the flange part is larger than a diameter of the fitting hole.

### TECHNICAL FIELD

The present disclosure relates to a fuel injection valve and an internal combustion engine.

The present application claims priority based on Japanese Patent Application No. 2023-033920 filed on Mar. 6, 2023, the entire content of which is incorporated herein by reference.

### BACKGROUND ART

In a fuel injection valve in a diesel engine, fuel filtered by a fuel filter is boosted by a high-pressure pump and injected through a fuel injection nozzle. For example, if foreign matter is generated due to, for example, the detachment of machining burrs from equipment (e.g., high-pressure pumps, etc.) installed downstream of the fuel filter in the fuel passage, the foreign matter may clog the orifice of the fuel injection nozzle, resulting in reduced injection performance of the fuel injection nozzle, reduced power output of the diesel engine, damage to the fuel injection nozzle, and other defects.

The fuel injection valve described in Patent Document 1 is equipped with an edge filter to remove foreign matter generated downstream of the fuel filter upstream of the fuel injection nozzle in order to suppress such defects.

### Citation List

### Patent Literature

Patent Document 1: JP2002-521605A (translation of a PCT application)

### SUMMARY

### Problems to be Solved

In the fuel injection valve described in Patent Document 1, an insertion hole with an inner diameter larger than the basic passage diameter of the fuel passage is provided in the middle of the fuel passage, into which the edge filter is press-fitted. However, as the fuel injection pressure in the fuel injection valve rises, the inner diameter of the fuel passage expands due to the high pressure, resulting in a decrease in the static friction force acting on the edge filter. Therefore, when the fuel pressure drops downstream of the edge filter upon injecting fuel through the fuel injection nozzle, the edge filter may shift toward the fuel injection nozzle and block the fuel passage, posing a risk of the fuel injection nozzle becoming unable to inject fuel.

In view of the above, an object of at least one embodiment of the present disclosure is to provide a fuel injection valve and an internal combustion engine including the same that can reduce the risk of the fuel injection nozzle becoming unable to inject fuel.

### Solution to the Problems

In order to achieve the above-described object, a fuel injection valve for an internal combustion engine according to at least one embodiment of the present disclosure is provided with: a fuel injection nozzle; a fuel passage for supplying fuel to the fuel injection nozzle; and an edge filter disposed in the fuel passage. The edge filter includes an edge filter body and a flange part disposed upstream of the edge filter body in the fuel passage. The fuel passage includes a fitting hole which mates with the edge filter body. The diameter of the flange part is larger than the diameter of the fitting hole.

In order to achieve the above-described object, an internal combustion engine according to at least one embodiment of the present disclosure is provided with: the above-described fuel injection valve; and a combustion chamber for burning fuel injected by the fuel injection valve.

### Advantageous Effects

At least one embodiment of the present disclosure provides a fuel injection valve and an internal combustion engine including the same that can reduce the risk of the fuel injection nozzle becoming unable to inject fuel.

### BRIEF DESCRIPTION OF DRAWINGS

FIG. 1 is a schematic cross-sectional view showing the configuration of a fuel injection valve 2 according to an embodiment.

FIG. 2 is a schematic cross-sectional view of a part of the fuel passage 6 and the edge filter 10 shown in FIG. 1.

FIG. 3 is a diagram of the edge filter 10 and the fitting hole 24 shown in FIG. 2 as viewed from the upstream side of the edge filter 10 along the central axis O1 of the edge filter 10.

### DETAILED DESCRIPTION

Embodiments of the present disclosure will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

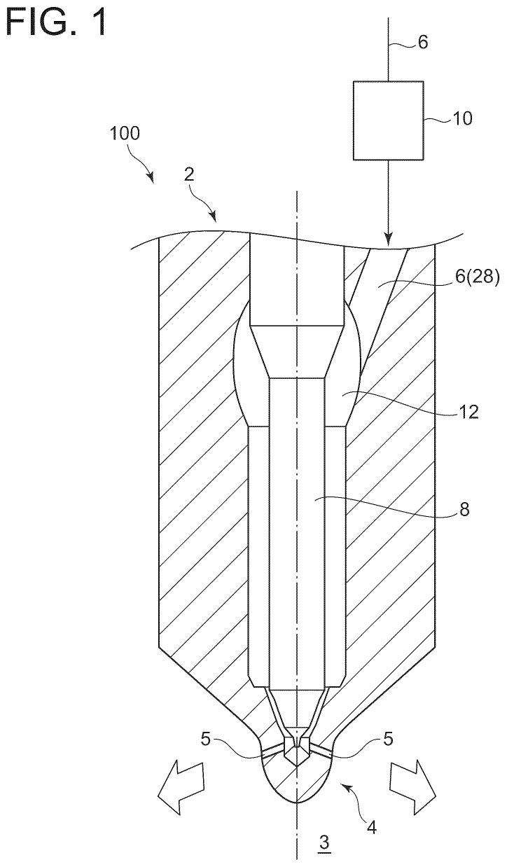

FIG. 1 is a schematic cross-sectional view showing the configuration of a fuel injection valve 2 according to an embodiment.

As shown in FIG. 1, the fuel injection valve 2 is provided with a fuel injection nozzle 4 for injecting fuel into a combustion chamber 3 of a diesel engine 100 as an internal combustion engine, a fuel passage 6 for supplying fuel to the fuel injection nozzle 4, a needle valve 8 (valve body) for opening and closing a plurality of nozzle holes 5 formed at the tip of the fuel injection nozzle 4, and an edge filter 10 disposed in the fuel passage 6.

A chamber 12 is formed inside the fuel injection nozzle 4 to receive a tip portion of the needle valve 8, and the downstream end of the fuel passage 6 is connected to the chamber 12. A high-pressure pump (not shown) is installed upstream of the edge filter 10 in the fuel passage 6. High-pressure fuel boosted by the high-pressure pump flows through the fuel passage 6, is filtered by the edge filter 10, and then enters the chamber 12.

The needle valve 8 is biased toward the plurality of nozzle holes 5 (toward the tip of the fuel injection nozzle 4) by a coil spring (not shown). When the pressure of fuel in the chamber 12 increases, the needle valve 8 moves away from the plurality of nozzle holes 5 against the biasing force of the coil spring to open the plurality of nozzle holes 5, and the fuel in chamber 12 is injected into the combustion chamber 3 through the plurality of nozzle holes 5.

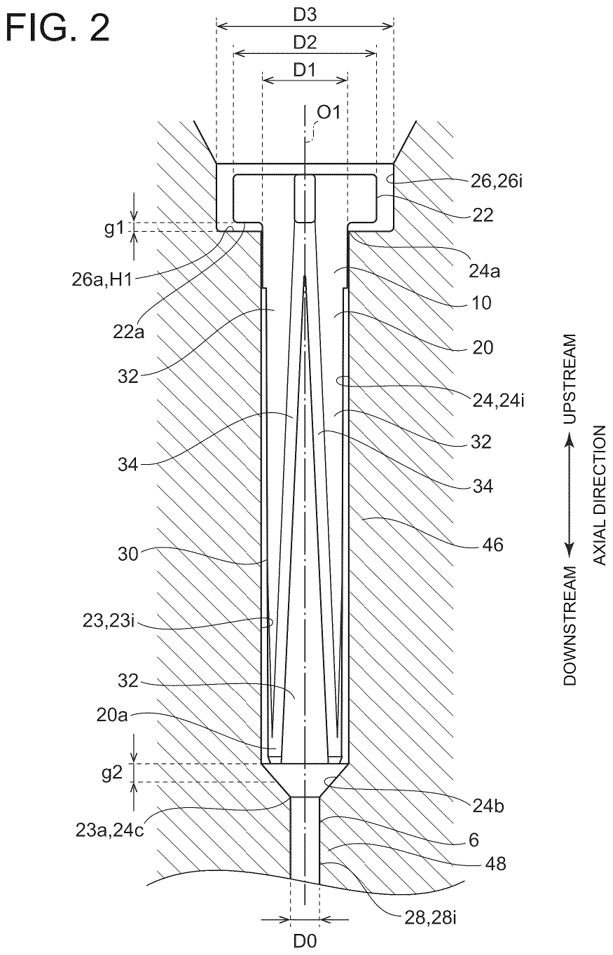

FIG. 2 is a schematic cross-sectional view of a part of the fuel passage 6 and the edge filter 10 shown in FIG. 1.

As shown in FIG. 2, the edge filter 10 includes a substantially cylindrical edge filter body 20 and a flange part 22 provided adjacent to the edge filter body 20 upstream of the edge filter body 20 in the fuel passage 6. The fuel passage 6 includes an edge filter insertion hole 23 into which the edge filter 10 is inserted, and a connecting passage 28 that connects the downstream end 23a of the edge filter insertion hole 23 to the chamber 12 (see FIG. 1). The edge filter insertion hole 23 and the connecting passage 28 are connected in series in the fuel flow direction, and each of the edge filter insertion hole 23 and the connecting passage 28 constitutes a section of the fuel passage 6. An edge filter insertion hole forming part 46 that forms the edge filter insertion hole 23 may be formed integrally with a connecting passage forming part 48 that forms the connecting passage 28.

In the illustrated exemplary embodiment, the central axis O1 of the edge filter insertion hole 23 extends in a straight line. The edge filter insertion hole 23 includes a body fitting hole 24 into which the edge filter body 20 is press-fitted and which mates with the edge filter body 20, and a flange receiving hole 26 which receives the flange part 22. The flange receiving hole 26 is provided adjacent to the body fitting hole 24 upstream of the body fitting hole 24, and each of the flange receiving hole 26 and the body fitting hole 24 extends along the central axis O1. The flange receiving hole 26, the body fitting hole 24, and the connecting passage 28 are connected in series in the fuel flow direction, and each of the flange receiving hole 26 and the body fitting hole 24 constitutes a section of the fuel passage 6. The central axis O1 of the edge filter insertion hole 23 coincides with the central axis O1 of the edge filter 10.

In the following, unless otherwise noted, “axial direction” means the direction parallel to the central axis O1, “circumferential direction” means the circumferential direction around the central axis O1, and “radial direction” means the radial direction around the central axis O1. Further, in the following, unless otherwise noted, “upstream” means upstream with respect to the fuel flow direction in the fuel passage 6, and “downstream” means downstream with respect to the fuel flow direction in the fuel passage 6.

In the illustrated exemplary embodiment, the body fitting hole 24 has a circular cross-sectional shape perpendicular to the central axis O1, and the hole diameter D1 of the body fitting hole 24 is larger than the basic passage diameter D0 of the fuel passage 6. Further, the flange diameter D2 of the flange part 22 is larger than the hole diameter D1 of the body fitting hole 24. The basic passage diameter D0 of the fuel passage 6 is the basic diameter of the fuel passage 6, for example, the diameter of the connecting passage 28. The flange diameter means the diameter of the flange part in axial view, the passage diameter means the inner diameter of the passage, i.e., the diameter of the passage, and the hole diameter means the inner diameter of the hole, i.e., the diameter of the hole.

The hole diameter D1 of the body fitting hole 24 is constant along the central axis O1, and the inner peripheral surface 24i of the body fitting hole 24 is connected to the inner peripheral surface 28i of the connecting passage 28 by a stepped surface 24b. The stepped surface 24b is a wall surface that forms the outlet 24c of the body fitting hole 24 (inlet of connecting passage 28), and in the illustrated example, the stepped surface 24b slopes so that the distance from the central axis O1 decreases toward the downstream side.

The flange receiving hole 26 has a circular cross-sectional shape perpendicular to the central axis O1, and the hole diameter D3 of the flange receiving hole 26 is larger than the hole diameter D1 of the body fitting hole 24. Additionally, the hole diameter D3 of the flange receiving hole 26 is larger than the flange diameter D2 of the flange part 22. The inner peripheral surface 23i of the edge filter insertion hole 23 includes the inner peripheral surface 24i of the body fitting hole 24, the inner peripheral surface 26i of the flange receiving hole 26, and a stepped surface 26a (downstream end surface of flange receiving hole 26) connecting the inner peripheral surface 24i and the inner peripheral surface 26i. In other words, the edge filter insertion hole 23 is formed as a stepped hole with the stepped surface 26a. The stepped surface 26a is a wall surface that forms the inlet 24a of the body fitting hole 24 (inlet of connecting passage 28), and in the illustrated example, it is formed along a plane H1 perpendicular to the central axis O1. A surface 22a of the flange part 22 facing the body fitting hole 24 is also formed along a plane perpendicular to the central axis O1, and the stepped surface 26a is configured as a flange-opposing surface that faces the surface 22a of the flange part 22 facing the body fitting hole 24. A gap g1 is formed in the axial direction between the surface 22a of the flange part 22 facing the body fitting hole 24 and the stepped surface 26a.

Further, a gap g2 is formed in the axial direction between the downstream end part 20a of the edge filter body 20 and the stepped surface 26a (downstream end surface of body fitting hole 24). Here, the size of the gap g1 formed in the axial direction between the surface 22a of the flange part 22 facing the body fitting hole 24 and the stepped surface 26a is smaller than the size of the gap g2 formed in the axial direction between the downstream end part 20a of the edge filter body 20 and the stepped surface 24b. In the illustrated example, where the stepped surface 24b slopes, the size of the gap g2 means the minimum size of the gap g2 formed in the axial direction between the end part 20a and the stepped surface 24b.

As shown in FIG. 2, the outer peripheral surface 30 of the edge filter body 20 has a plurality of grooves 32. Each of the grooves 32 extends along the axial direction, and the grooves 32 are arranged at intervals in the circumferential direction. Further, the outer peripheral surface 30 of the edge filter body 20 has a plurality of partition walls 34, each of which partitions circumferentially adjacent grooves 32 of the plurality of grooves 32, and the tip end (radially outer end) of each partition wall 34 faces the inner peripheral surface 24i of the body fitting hole 24 with a minute gap in between. Thus, when fuel flowing in the fuel passage 6 passes through the edge filter 10, foreign matter larger than the gap between the tip end of each partition wall 34 of the edge filter body 20 and the inner peripheral surface 24i of the body fitting hole 24 cannot pass through the gap and are collected in the grooves 32, whereby the fuel is filtered.

With the above-described fuel injection valve 2, even if the edge filter 10 is shifted to the downstream side of the fuel passage 6 (toward the fuel injection nozzle 4 in FIG. 1) due to the differential pressure between upstream and downstream of the edge filter 10, before the downstream end part 20a of the edge filter body 20 comes into contact with the stepped surface 24b (wall surface that forms the outlet 24c of the body fitting hole 24) and blocks the fuel passage 6, the flange part 22 comes into contact with the stepped surface 26a (wall surface that forms the inlet 24a of the body fitting hole 24) and stops, thus preventing the edge filter body 20 from blocking the fuel passage 6. This reduces the risk of the fuel injection nozzle 4 being unable to inject fuel.

In addition, since the gap g1 is formed in the axial direction between the surface 22a of the flange part 22 facing the body fitting hole 24 and the stepped surface 26a, the flange part 22 does not contact the stepped surface 26a when the edge filter body 20 is press-fitted into the body fitting hole 24. This reduces the risk of indentations on the stepped surface 26a or the flange part 22, or metal powder being generated, due to contact between the stepped surface 26a and the flange part 22. Thus, it is possible to achieve stable fuel injection performance of the fuel injection nozzle 4.

In addition, since the stepped surface 26a is formed along the plane H1 perpendicular to the central axis O1, it is easier to control the size of the gap between the flange part 22 of the edge filter 10 and the wall surface that forms the stepped surface 26a.

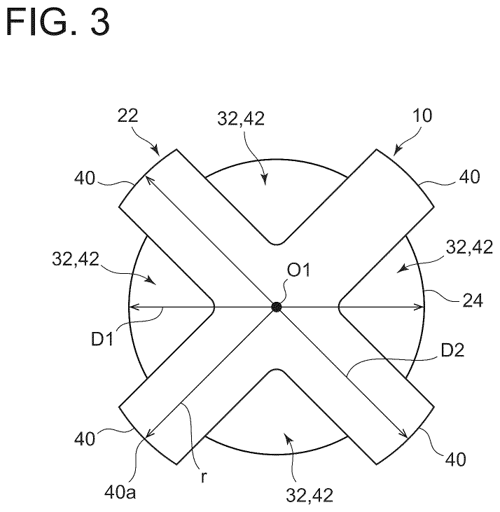

FIG. 3 is a diagram of the edge filter 10 and the body fitting hole 24 shown in FIG. 2 as viewed from the upstream side of the edge filter 10 along the central axis O1 of the edge filter 10.

As shown in FIG. 3, the flange part 22 includes a plurality of projecting parts 40 extending radially around the central axis O1. In the exemplary embodiment shown in FIG. 3, the flange part 22 has four projecting parts 40 extending radially around the central axis O1, the projecting parts 40 being arranged at 90-degree intervals in the circumferential direction and extending outward along the radial direction. The space 42 between circumferentially adjacent projecting parts 40 communicates with the interior space of the respective groove 32.

In the exemplary embodiment shown in FIG. 3, let r be the distance between the tip end 40a of each projecting part 40 (radially outer end of each projecting part 40) and the central axis O1, the flange diameter D2 of the flange part 22 is equivalent to twice of the distance r, satisfying D2=2r. Therefore, the fact that the diameter D2 of the flange part 22 is larger than the hole diameter D1 of the body fitting hole 24 means that the distance r is larger than the radius of the body fitting hole 24.

According to the configuration shown in FIG. 3, since the flange part 22 includes a plurality of projecting parts 40 extending radially around the central axis O1, fuel can be supplied to the edge filter 10 through the space 42 between circumferentially adjacent projecting parts 40. This prevents the supply of fuel to the edge filter body 20 from being blocked by the flange part 22.

The present disclosure is not limited to the embodiments described above, but includes modifications to the embodiments described above, and embodiments composed of combinations of those embodiments.

For example, in the configuration shown in FIG. 2, the stepped surface 26a is formed along the plane H1 perpendicular to the axial direction, but in other embodiments, the stepped surface 26a may slope so that the distance from the central axis Ol increases toward the upstream side of the fuel passage 6, for example.

The configuration of the edge filter body 20 of the edge filter 10 is not limited to the configuration described above, but any known configuration can be adopted. For example, in the configuration shown in FIG. 3, the flange part 22 has four projecting parts 40, but the flange part 22 may have any number of projecting parts 40, as long as it is two or more.

The contents described in the above embodiments would be understood as follows, for instance.
(1) A fuel injection valve for an internal combustion engine according to at least one embodiment of the present disclosure is a fuel injection valve (e.g., the above-described fuel injection valve 2) provided with: a fuel injection nozzle (e.g., the above-described fuel injection nozzle 4); a fuel passage (e.g., the above-described fuel passage 6) for supplying fuel to the fuel injection nozzle; and an edge filter (e.g., the above-described edge filter 10) disposed in the fuel passage. The edge filter includes an edge filter body (e.g., the above-described edge filter body 20) and a flange part (e.g., the above-described flange part 22) disposed upstream of the edge filter body in the fuel passage. The fuel passage includes a fitting hole (e.g., the above-described body fitting hole 24) which mates with the edge filter body. A diameter of the flange part is larger than a diameter of the fitting hole.

With the fuel injection valve described in (1), even if the edge filter is shifted to the downstream side of the fuel passage due to the differential pressure between upstream and downstream of the edge filter, before the edge filter body blocks the fuel passage at the outlet side of the fitting hole, the flange part of the edge filter comes into contact with the wall surface that forms the inlet of the fitting hole and stops, thus preventing the edge filter from blocking the fuel passage. This reduces the risk of the fuel injection nozzle being unable to inject fuel.
(2) In some embodiments, in the fuel injection valve described in (1), the flange part includes a plurality of projecting parts (e.g., the above-described plurality of projecting parts 40) extending radially around a central axis (e.g., the above-described central axis O1) of the edge filter.

With the fuel injection valve described in (2), fuel can be supplied to the edge filter through the space between circumferentially adjacent projecting parts, thus preventing the supply of fuel from the upstream side of the edge filter to the edge filter body from being blocked by the flange part, while achieving the effect of the configuration described in (1).
(3) In some embodiments, in the fuel injection valve described in (1) or (2), a first gap (e.g., the above-described gap g1) is formed between the flange part and a wall surface (e.g., the above-described stepped surface 26a) that forms an inlet of the fitting hole.

With the fuel injection valve described in (3), the flange part does not contact the wall surface that forms the inlet of the fitting hole when the edge filter body is press-fitted into the fitting hole. This reduces the risk of indentations on the wall surface or the flange part, or metal powder being generated, due to contact between the wall surface and the flange part. Thus, it is possible to achieve stable fuel injection performance of the fuel injection nozzle.
(4) In some embodiments, in the fuel injection valve described in any one (1) to (3), a second gap (e.g., the above-described gap g2) is formed between a downstream end (e.g., the above-described end part 20a) of the edge filter body and a wall surface (e.g., the above-described stepped surface 24b) that forms an outlet of the fitting hole. The first gap is smaller than the second gap.

With the fuel injection valve described in (4), even if the edge filter is shifted to the downstream side of the fuel passage due to the differential pressure between upstream and downstream of the edge filter, before the downstream end of the edge filter body comes into contact with the wall surface that forms the outlet of the fitting hole, the flange part of the edge filter comes into contact with the wall surface that forms the inlet of the fitting hole and stops, thus preventing the edge filter from blocking the fuel passage. This reduces the risk of the fuel injection nozzle being unable to inject fuel.
(5) In some embodiments, in the fuel injection valve described in (3) or (4), the wall surface (e.g., the above-described stepped surface 26a) that forms the inlet of the fitting hole is formed along a plane (e.g., the above-described plane H1) perpendicular to a central axis of the edge filter.

With the fuel injection valve described in (5), it is easier to control the size of the gap between the flange part of the edge filter and the wall surface that forms the inlet of the fitting hole.
(6) An internal combustion engine (e.g., the above-described diesel engine 100) according to at least one embodiment of the present disclosure is provided with: the fuel injection valve described in any one of (1) to (5) above; and a combustion chamber (e.g., the above-described combustion chamber 3) for burning fuel injected by the fuel injection valve.

With the internal combustion engine described in (6), since the fuel injection valve described in any one of (1) to (5) is included, it is possible to reduce the risk of the fuel injection nozzle being unable to inject fuel.

### Reference Signs List

2 Fuel injection valve
3 Combustion chamber
4 Fuel injection nozzle
5 Nozzle hole
6 Fuel passage
8 Needle valve
10 Edge filter
12 Chamber
20 Edge filter body
20a End part
22 Flange part
22a Surface
23 Edge filter insertion hole
23a Downstream end
23i, 24i, 26i, 28i Inner peripheral surface
24 Body fitting hole
24a Inlet
24b, 26a Stepped surface
24b End surface
24c Outlet
26 Flange receiving hole
28 Connecting passage
30 Outer peripheral surface
32 Groove
34 Partition wall
40 Projecting part
40a Tip end
42 Space
46 Edge filter insertion hole forming part
48 Connecting passage forming part
100 Diesel engine

1. A fuel injection valve for an internal combustion engine, comprising:
a fuel injection nozzle;
a fuel passage for supplying fuel to the fuel injection nozzle; and
an edge filter disposed in the fuel passage,
wherein the edge filter includes an edge filter body and a flange part disposed upstream of the edge filter body in the fuel passage,
wherein the fuel passage includes a fitting hole which mates with the edge filter body, and
wherein a diameter of the flange part is larger than a diameter of the fitting hole.

2. The fuel injection valve according to claim 1,
wherein the flange part includes a plurality of projecting parts extending radially around a central axis of the edge filter.

3. The fuel injection valve according to claim 1,
wherein a first gap is formed between the flange part and a wall surface that forms an inlet of the fitting hole.

4. The fuel injection valve according to claim 3,
wherein a second gap is formed between a downstream end part of the edge filter body and a wall surface that forms an outlet of the fitting hole, and
wherein the first gap is smaller than the second gap.

5. The fuel injection valve according to claim 3,
wherein the wall surface that forms the inlet of the fitting hole is formed along a plane perpendicular to a central axis of the edge filter.

6. An internal combustion engine, comprising:
the fuel injection valve according to claim 1; and
a combustion chamber for burning fuel injected by the fuel injection valve.
